(19) United States
(12) Patent Application Publication
(10) Pub. No.: US 2018/0150919 A1
(43) Pub. Date: May 31, 2018

(54) Method and apparatus for Meal Planning and Optimization

(71) Applicant: Benjamin Robert Drolet, Chicago, IL (US)

(72) Inventor: Benjamin Robert Drolet, Chicago, IL (US)

(21) Appl. No.: 15/364,243

(22) Filed: Nov. 29, 2016

(51) Int. Cl. G06Q 50/12; G06Q 10/08; G06Q 30/06

(52) U.S. Cl. CPC G06Q 50/12; G06Q 30/0635; G06Q 10/087

(57) ABSTRACT

A method for meal optizimation, by a data processor, comprising: planning meals, with a meal planning interface module, specifying a future date and determining meal options based on optimization of perishable goods in an inventory; specifying when the number of meals are to be prepared automatically and/or manually with a voice recognition device and/or an image recognition device and/or bar code scanning device and/or other scanning devices and/or manually with a user interface, including updating and/or adding and/or removing the items at a point of entry into and/or out of a food storage area and/or a plurality of food storage areas, such as at a doorway and/or window and/or counter and/or loading area and/or unloading area; and ordering and or delivering and/or arranging for delivery, manually and/or automatically, of the items from a grocery store or a plurality of grocery stores and/or from other sites and/or other food item sources.

### CROSS-REFERENCE TO RELATED APPLICATIONS

This application claims priority-to provisional application 62/260,520 filed on Nov. 29,2015, and is incorporated herein, by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The exemplary embodiment are in the technical Held of perishable goods optimization. Particularly, the exemplary embodiments are in the technical field of human interface with perishable goods usage optimization. More particularly, the exemplary embodiments are in the technical field of enhancing human interface with food and meal planning optimization.

Furthermore, the exemplary embodiments are in the field of enhancing human meal planning and meal optimization for one and/or several sites.

Currently, a method and apparatus to provide a more efficient and effective way to plan for meals, optimize perishable food usage, and scalable solutions are needed.

### SUMMARY OF THE INVENTION

The following is intended to be a brief summary of the invention and is not intended to limit the scope of the invention.

The exemplary embodiments enhance human ability to plan their meals optimize usage of available foods, optimize potential options for meals givers several sites to choose from, optimize meal choices based on desired cuisine and/or number of people needed to be served. Exemplary embodiments enhance human ability to track the perishable nature of available food, utilize multiple input and output devices to track food inventories, to be able to provide options to choose from in planning a meal. Exemplary embodiments allow interconnectivity with other similar apparatus' which can interface each other and provide for further optimization. The exemplary embodiments are configurable. The exemplary embodiments may be automatically or manually operated, and/or independently and/or jointly, engaged in concert.

### BRIEF DESCRIPTION OF THE DRAWINGS

These and other features, aspects, and advantages of the present invention will become better understood with regard to the following description, appended claims, and accompanying, drawings where:

FIG. 1 illustrates the interfacing of the modules of the innovation;

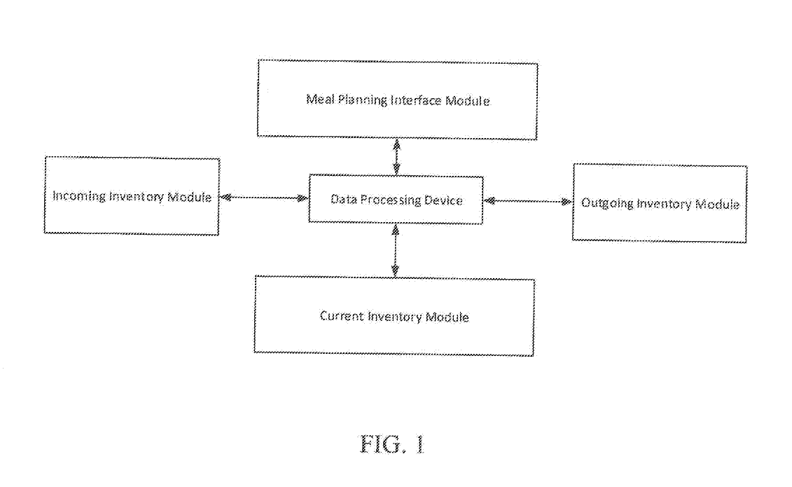

FIG. 2 illustrates the interfacing of the devices of the incoming inventory module:

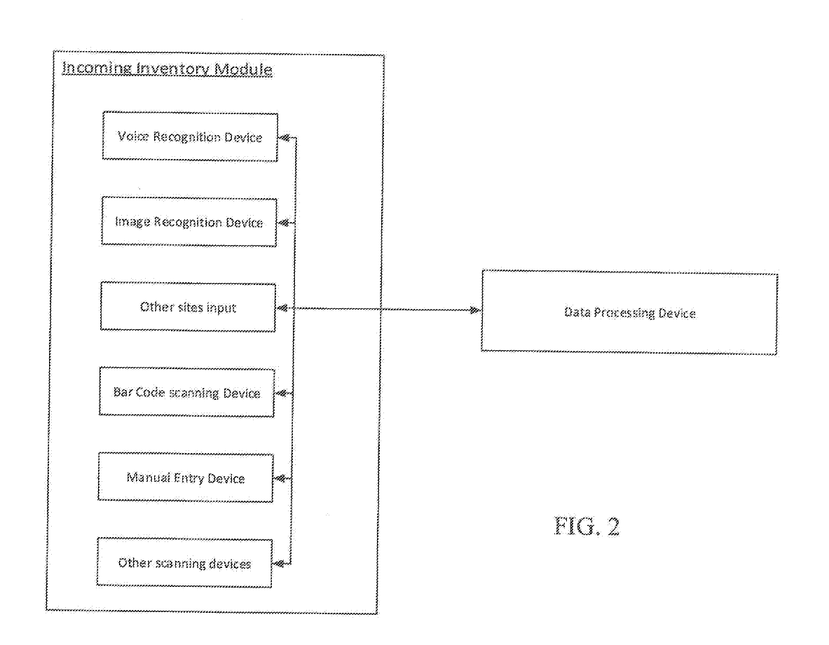

FIG. 3 illustrates the interfacing of the devices of the outgoing inventory module;

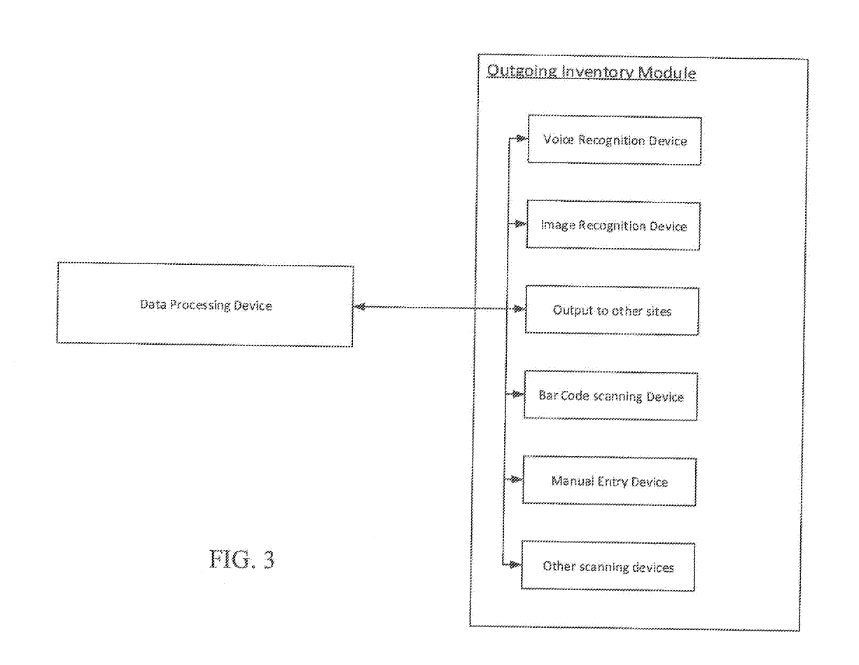

FIG. 4 illustrating the interfacing of the various specifications and functionality of the meal planning interface module; and

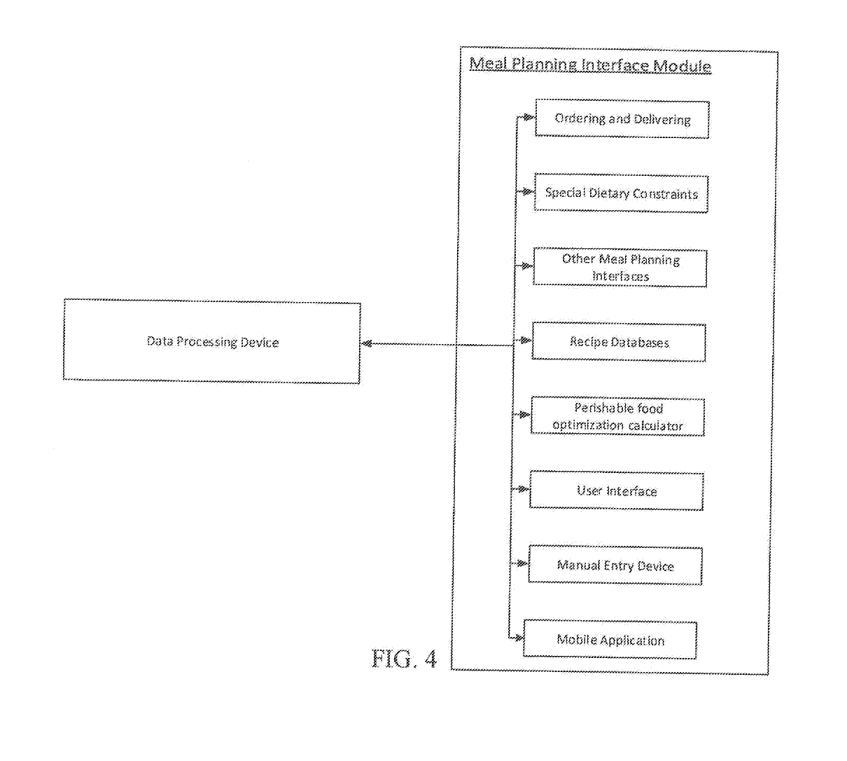

FIG. 5 illustrates the interfacing of the resources of the current inventory module.

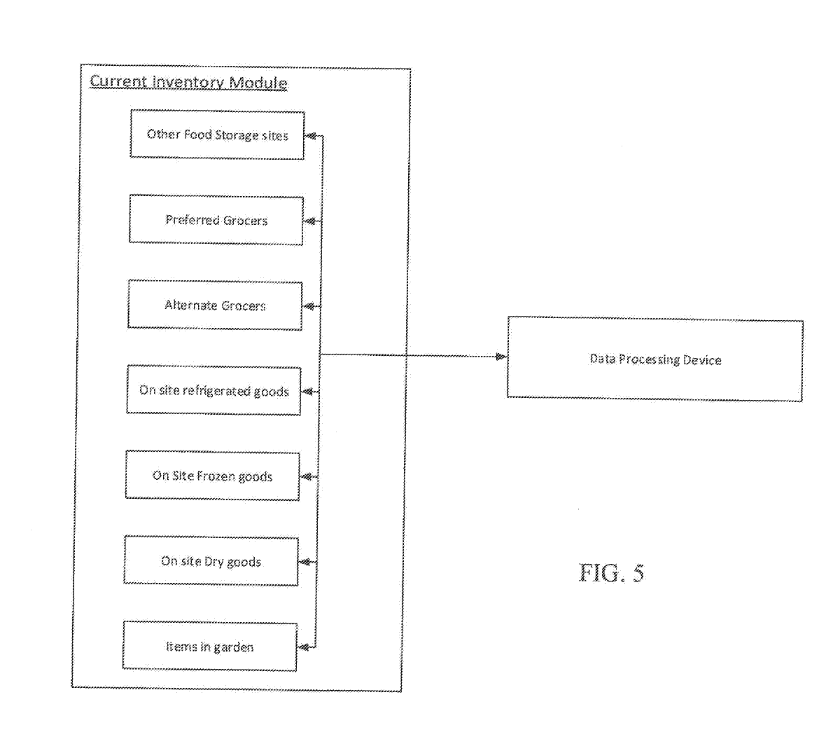

### DETAILED DESCRIPTION THE INVENTION

A method for meal optimization, by a data processor, comprising: planning meals, with a meal planning interface module, the meal planning interface module comprising: specifying a number of meals to be prepared; specifying a future date and determining meal options based on optimization of perishable goods in an inventory, specifying when the number of meals are to be prepared; specifying a dietary constraint; specifying an ethnic and/or cultural and/or religious constraint; specifying meal options based on time and/or budgetary constraints; specifying a recipe for the meals to be prepared; and identifying items, with a current inventory module, the current inventory module comprising: identifying the items available in inventory, including refrigerated goods and/or dry goods and/or frozen goods; identifying the items available at preferred grocer; identifying the items available at alternative grocer; identifying the items available at other meal planning site inventory; identifying the items available at a garden; identifying the items available at other food item source; and updating with an incoming inventory module and/or an outgoing inventory module, the current inventory module; automatically and/or manually with a voice recognition device and/or an image recognition device and/or bar code scanning device and/or other scanning devices and/or manually with a user interface, including updating and/or adding and/or removing the items at a point of entry into and/or out of a food storage area and/or a plurality of food storage areas, such as at a doorway and/or window and/or counter and/or loading area and/or unloading area; and ordering and or delivering and/or arranging for delivery, manually and/or automatically, of the items, from a grocery store or a plurality of grocery stores and/or from other food preparation sites and/or other food item sources, with a meal planning interface module.

An exemplary embodiment of the innovation is an apparatus which can be used to assess what food and in what quantities are in a specified kitchen, what meals may be prepared with the existing food items, and to determine what additional items are needed in order to prepare a specified meal, and to choose from meal options in order to prevent the loss of perishable food items, given a future time frame.

An exemplary embodiment can allow the apparatus to be able to choose from one and/or a plurality of recipes form one and/or a plurality of databases, based on ethnicity selection and/or number of servings and/or special dietary needs, such as vegan, vegetarian, kosher, non-gluten, non-lactose, and/or other special dietary restrictions, and/or protein requirements and/or carbohydrate requirements and/or fat requirements, and to determine what options are available to be met with the existing food items present in the kitchen.

An exemplary embodiment can allow the apparatus to be able to search from one and/or a plurality of recipe databases based on specified preferences and/or past search history and/or present geographical location, in assessing what facilities, such as grocery stores, farmers' markets, and/or other sites from which additional food items can be obtained, and to determine what meals and/or for how many servings can be prepared, if certain additional items were chosen.

An exemplary embodiment can maintain a current inventory of all food items in a food preparation site and/or in grocery stores from which additional items could be obtained and/or in other food preparation sites from which additional items could be obtained.

An exemplary embodiment can utilize one and/or a plurality of methods of maintaining accurate inventory, such as barcode scanning, voice recognition entry, image scanning, manual entry, and other methods that can identify an item that is being added to the inventory and/or identity an item that is being removed from the inventory. The items may be added and/or removed from the inventory at the point of entry into the food item storage areas, such as at the door, window, counter, loading and/or unloading area, and can be accomplished manually and/or automatically.

An exemplary embodiment can utilize time stamp data of perishable items in inventory, such as produce and/or refrigerated goods and/or dry goods in inventory and can provide a calculated date at which the perishable food items would no longer be suitable for human consumption. An exemplary embodiment can provide for a mechanism to preventing loss of food items due to becoming perishable by providing the meal planning interface to select recipe choices that can utilize the perishable food items while still suitable for human consumption, given a future time frame.

An exemplary embodiment can allow the meal planning interface to reside on a mobile device, computer, tablet, mobile website, and/or using an application as the meal planning interface residing on a mobile device

An exemplary embodiment can allow the meal planning to provide meal options given constraints such as time needed to prepare and/or the desire to use only items that are readily available and/or number of servings required and/or number of servings possible given the readily available food items.

An exemplary embodiment can allow the meal planning interface to utilize past meal choices and/or past search histories and/or present geographical location.

An exemplary embodiment can allow the meal optimization apparatus to interface with available grocery stores and/or other food preparation sites and/or other food item sources in order to access their food item inventories and/or submit a shopping order and/or to arrange for a delivery of food items and/or to print out a shopping list for one/and or a plurality of food item providers, for a predetermined time, now or at a predetermined date in the future.

An exemplary embodiment can allow the meal planning interface to select meals based on a predetermined amount of money that can be spent on one and/or a plurality of meals.

An exemplary embodiment can allow the meal planning interface with other meal planning interfaces.

While the foregoing written description of the exemplary embodiments enables one of ordinary skill to make and use what is considered presently to be the best mode thereof, those of ordinary skill will understand and appreciate the existence of variations, combinations, and equivalents of the specific embodiment, method, and examples herein. The exemplary embodiments should therefore not be limited by the above described embodiment, method, and examples, but all embodiments and methods within the scope and spirit of the exemplary embodiments as claimed.

Insofar as the description above and the accompanying drawings disclose any additional subject matter that is not within scope of the claims below, the inventions are not dedicated to the public and the right to file one or more applications to claim such additional inventions is reserved.

What is claimed is:

1. A method for meal optimization, by a data processor, comprising:
planning meals, with a meal planning interface module, the meal planning interface module used to carry out the steps of:
specifying a number of meals to be prepared;
specifying a future date and determining meal options based on optimization of perishable goods in an inventory;
specifying when the number of meals are to be prepared;
specifying a dietary constraint;
specifying an ethnic and/or cultural and/or religious constraint;
specifying meal options based on time and/or budgetary constraints;
specifying a recipe for the meals to be prepared; and
identifying items, with a current inventory module, the current inventory module comprising:
identifying the items available in inventory, including refrigerated goods and/or dry goods and/or frozen goods;
identifying the items available at preferred grocer;
identifying the items available at alternative grocer:
identifying the items available at other meal planning site inventory;
identifying the items available at a garden;
identifying the items available at other food item sources: and
updating with an incoming inventory module and/or an outgoing inventory module, the current inventory module; automatically and/or manual with a voice recognition device and/or an image recognition device and/or bar code scanning device and/or other scanning devices and/or manually with a user interface, including updating and/or adding and/or removing the items at a point of entry into and/or out of a fond storage area and/or a plurality of food storage areas, such as at a doorway and/or window and/or counter and/or loading area and/or unloading area; and
ordering and or delivering and/or arranging for delivery, manually and/or automatically, of the items from a grocery store or a plurality of grocery stores and/or from other food preparation sites and/or other food item sources, with a meal planning interface module.

2. The method as recited in claim 1, wherein the incoming inventory module further comprises:
identifying and/or recording incoming items with a voice recognition device;
identifying and/or recording incoming items with a scanning-device;
identifying and/or recording incoming items with an imaging device;
identifying and/or recording incoming item from other sites; and
identifying and/or recording incoming items with a manual entry device.

3. The method as recited in claim 2 wherein the scanning device further comprises a bar code scan and/or a RFID.

4. The method as recited in method 2 wherein the imaging device includes an image auto-identification of items.

5. The method as recited in claim 1, wherein the outgoing inventory module further comprises:
identifying and/or recording incoming items with a voice recognition device;
identifying and/or recording incoming items with a scanning device;
identifying and/or recording incoming items with an imaging device;
identifying and/or recording incoming item from other sites; ands
identifying and/or recording incoming items with a manual entry device.

6. The method as recited in claim 5 wherein the scanning device further comprises bar code scan and/or RFID.

7. The method as recited in method 5 wherein the imaging device includes image auto identification of items.
8. A system for meal optimization, the system comprising:
planning meals, with a meal planning interface module, the meal planning interface module used to:
specify a number of meals to be prepared;
specify a future date and determining meal options based on optimization, of perishable goods in an inventory;
specify when the number of meals are to be prepared;
specify a dietary constraint;
specify an ethnic and/or cultural and/or religious constraint;
specify meal options based on time and/or budgetary constraints;
specify a recipe for the meals to be prepared; and
identify items, with a current inventory module, the current inventory module used to:
identify the items available in inventory, including refrigerated goods and/or dry goods and/or frozen goods;
identify the hems available at preferred grocer;
identify the items available at alternative grocer;
identify the items available at other meal planning site inventory;
identify the items available at a garden;
identify the items available at other food item sources; and.
to update wife an incoming inventory module and/or an outgoing inventory module, the current inventory module; automatically and/or manually with a voice recognition device and/or an image recognition device and/or bar code scanning device and/or other scanning devices and/or manually with a user interface, including updating and/or adding and/or removing the items at a point of entry into and/or out of a food storage area and/or a plurality of food storage areas, such as at a doorway and/or window and/or counter and/or loading area and/or unloading area; and
ordering and or delivering and/or arranging for delivery, manually and/or automatically, of the items from a grocery store or a plurality of grocery stores and/or from other food preparation sites and/or other food item sources, with a meal planning interface module.

9. The system as recited in claim 8, wherein the incoming inventory module further:
identify and/or record incoming items with a voice recognition device;
identify and/or record incoming items with a scanning device;
identify and/or record incoming items with an imaging device;
identify and/or record incoming item from other sites; and
identify and/or record incoming items with a manual entry device.

10. The system as recited in claim 9 wherein the scanning device further comprises a bar code scan and/or a RFID.

11. The system as recited in method 9 wherein the imaging device includes an image auto-identification of items.

12. The system as recited in claim 8, wherein the outgoing inventory module further:
identify and/or record incoming items with a voice recognition device;
identify and/or record incoming items with a scanning device;
identity and/or record incoming items with an imaging device;
identify and/or record incoming item from other sites; and
identify and/or record incoming items with a manual entry device.

13. The system, as recited in claim 12 wherein the scanning device further comprises bar code scan and/or RFID.

14. An apparatus for meal optimization, the apparatus comprising:
a meal planning interface module, wherein the meal planning interface module;
specifies a number of meals to be prepared;
specifies a future date and determining meal options based on optimization of perishable goods in an inventory;
specifies when the number of meals are to be prepared;
specifies a dietary constraint;
specifies an ethnic and/or cultural and/or religions constraint;
specifies meal options based on time and/or budgetary constraints;
specifies a recipe-for the meals to be prepared; and
a current inventory module, wherein the current inventory module:
identifies the items available In inventory, including refrigerated goods and/or dry-goods and/or frozen goods;
identifies the-items available at preferred grocer;
identities the items available at alternative grocer;
identifies the items available at other meal planning site inventory;
identifies the items available at a garden;
identifies the items available at other food item sources; and
an incoming inventory module and/or an outgoing inventory module, the current inventory module; automatically and/or manually with a voice recognition device and/or an image recognition device and/or bar code scanning device and/or other scanning devices and/or manually with a user interface, including updating and/or adding and/or removing the items at a point of entry into and/or out of a food storage area and/or a plurality of food storage areas, such as at a doorway and/or window and/or counter and/or loading area and/or unloading area; and
ordering and or delivering and/or arranging for delivery, manually and/or automatically, of the items from a grocery store or a plurality of grocery stores and/or from other food preparation sites and/or other food hem sources, with a meal planning interface module.
